(19) United States
(12) Patent Application Publication
(10) Pub. No.: US 2003/0179973 A1
(43) Pub. Date: Sep. 25, 2003

(54) Optical modulator having a double diffusion optical waveguide and applications therefor

(75) Inventors: Shinichi Shimotsu, Emmaus, PA (US); Rangaraj Madabhushi, Macungie, PA (US)

Correspondence Address: HITT GAINES P.C., P.O. BOX 832570, RICHARDSON, TX, 75083, US

(73) Assignee: Agere Systems Guardian Corp., Orlando, FL (US)

(21) Appl. No.: 10/101,767

(22) Filed: Mar. 19, 2002

(51) Int. Cl. G02F 1/035; G02B 6/26

(52) U.S. Cl. 385/2; 385/40

(57) ABSTRACT

The present invention provides an optical modulator, a method of manufacture therefore, and an optical communications system including the optical modulator. The optical modulator may include a substrate, a waveguide located within the substrate and electrodes located over the substrate. Additionally, the waveguide includes a first doped region and a second doped region that overlaps the first doped region and is located adjacent an outer surface of the substrate and the electrodes.

### TECHNICAL FIELD OF THE INVENTION

The present invention is directed, in general, to an optical communications system and, more specifically, to an optical modulator and a method of manufacture therefor.

### BACKGROUND OF THE INVENTION

Certain types of waveguide-based optical switches, also referred to as optical modulators, are commonly used in optical communications systems. For example, high-speed optical modulators are used to encode information into an optical signal generated by an optical source, such as an optical laser, where the information is represented by changes in the amplitude of the optical signal. An optical modulator is a device that modulates or varies an amplitude of an optical signal passing therethrough. Typically, such modulation is achieved by driving current, via drive amplifiers, through electrodes associated with the modulator, to generate an electrical field that effects the optical signal. Additionally, low-speed optical modulators, also referred to as optical attenuators, may be used in conjunction with an optical amplifier to control the overall gain of an amplifier stage. This may be used to monitor gradual changes in a received optical signal, for example, as an optical source ages.

It is desirable to provide optical modulators that achieve both high optical signal throughput and low drive voltage. Achieving both goals has been problematic, however. For example, at high frequencies, such as 20 GHz and higher, drive amplifiers are limited to about 10 volts. Moreover, high throughput and low driving voltage are not mutually exclusive properties. For example, a high throughput maybe achieved when the mode size of a waveguide of the optical modulator matches the spot size of a fiber coupled to the optical modulator. But increasing the mode size of the waveguide to improve throughput causes an electric field associated with the waveguide to diverge, thus, requiring a higher driving voltage to operate the optical modulator. Conversely, a reduction in the drive voltage of the optical modulator may be achieved by reducing the size of the entire waveguide mode. But this results in lower throughput, because the spot size of the fiber no longer matches the mode size of the waveguide.

Thus, previous attempts to optimize the overall performance of the optical modulator have either sacrificed optical throughput to achieve a lower device voltage, or sacrificed a higher device voltage to achieve a higher optical throughput. Other attempts have focused on grinding the side wall of the waveguide to allow a stronger electrical field to be generated in the optical modulator. Such efforts, however, result in long manufacturing times, low device yields, unfavorable temperature sensitivity characteristics or high DC voltage drift. Therefore, previous efforts have produced inefficient optical modulators that do not attain the desired characteristics demanded by today's communications industry.

Accordingly, what is needed in the art is an optical modulator that attains the stringent requirements of the communications industry, while not experiencing the problems associated with previous optical modulators.

### SUMMARY OF THE INVENTION

To address the above-discussed deficiencies, the present invention provides, in one embodiment, an optical modulator comprising a substrate, electrodes located over the substrate and a waveguide located within the substrate. The waveguide includes a first doped region, and a second doped region overlapping the first doped region and adjacent an outer surface of the substrate and the electrodes.

Another embodiment of the present invention provides a method of manufacturing an optical modulator, comprising, providing a substrate, forming electrodes over the substrate; and constructing a waveguide within the substrate. The waveguide is constructed by forming a first doped region within the substrate, and forming a second doped region within the first doped region and adjacent an outer surface of the substrate and electrodes.

In yet another embodiment, the present invention provides an optical communications system. The system comprises the above described optical modulator, and input and output optical fibers coupled to the optical modulator.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

The invention is best understood from the following detailed description, when read with the accompanying FIGUREs. It is emphasized that in accordance with the standard practice in the optoelectronic industry, various features may not be drawn to scale. In fact, the dimensions of the various features may be arbitrarily increased or reduced for clarity of discussion. Reference is now made to the following descriptions taken in conjunction with the accompanying drawings, in which:

FIGS. 1A, 1B and 1C illustrate top plan and membranous cross-sectional views of one embodiment of an optical modulator constructed according to the principles of the present invention;

FIGS. 2A, 2B and 2C illustrate top plan and membranous cross-sectional views of an alternative embodiment of an optical modulator constructed according to the principles of the present invention;

FIGS. 3A, 3B and 3C illustrate top plan and membranous cross-sectional views of a partially completed optical modulator, in accordance with the principles of the present invention, after layering and patterning a first dopant layer to form a waveguide layout;

FIGS. 4A, 4B and 4C illustrate top plan and membranous cross-sectional views of the partially completed optical modulator, shown in FIGS. 3A-3C, after a thermal diffusion step;

FIGS. 5A, 5B and 5C illustrate top plan and membranous cross-sectional views of the partially completed optical modulator, illustrated in FIGS. 4A-4C, after layering and patterning a second dopant layer to form a modulator layout;

FIGS. 6A, 6B and 6C illustrate top plan and membranous cross-sectional views of an alternative partially completed optical modulator, shown in FIGS. 3A-3C, after layering and patterning a second dopant layer to form a modulator layout;

FIGS. 7A, 7B and 7C illustrate top plan and membranous cross-sectional views of the partially completed optical modulator, shown in FIGS. 5A-5C or 6A-6C, after a thermal diffusion step;

FIG. 8 illustrates a cross-sectional view of an optical communications system, which may form one environment in which an optical modulator, similar to that illustrated in FIG. 1, may be used; and

FIG. 9 illustrates a cross-sectional view of an alternative optical communications system, having a repeater, including a second transmitter and a second receiver, located between a transmitter and a receiver.

### DETAILED DESCRIPTION

The present invention uses a double diffusion technique to provide a reduced waveguide mode size located closer to electrodes associated with an optical modulator, thereby allowing a lower driving voltage. At the same time, the mode size matching between the waveguide and optical fiber is preserved, thereby maintaining a high optical signal throughput.

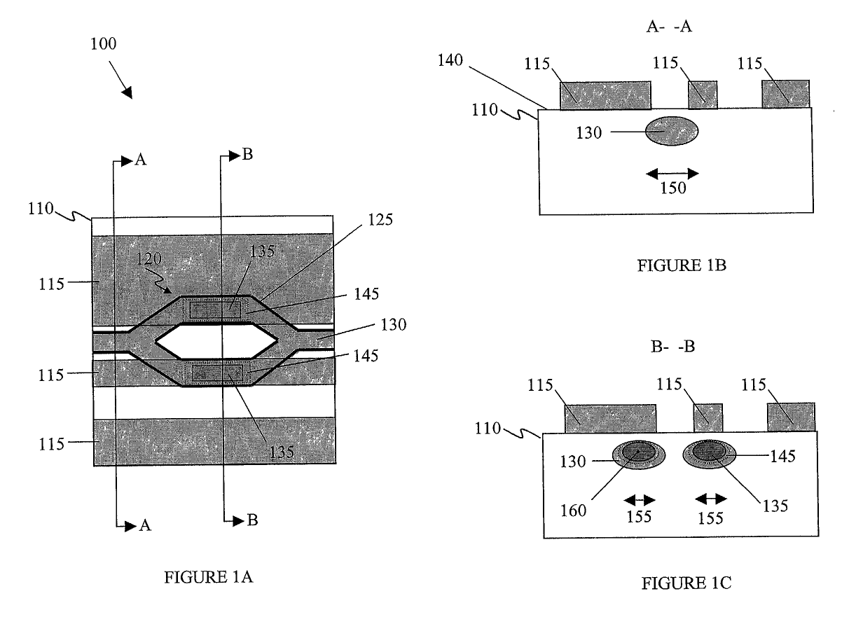

Referring initially to FIGS. 1A-1C, illustrated are various views of one embodiment of an optical modulator, 100, which has been constructed according to the principles of the present invention. FIG. 1A, shows a top plan view of the optical modulator, 100. FIGS. 1B and 1C show alternative views of the optical modulator 100 taken through membranous cross-sections, i.e., cross sectional views in the immediate vicinity of lines, A-A and B-B, respectively. The modulator, 100, includes a substrate, 110, which may be an electrooptic crystal, including lithium niobate or another similar substrate. A waveguide, 120, overlapping the substrate, 110, and electrodes, 115, located above the substrate, 110. To help illustrate underlying structures only, the electrodes, 115, are depicted in FIG. 1A and subsequent figures, as semitransparent. The waveguide, 120, could have any number of conventional layouts, not just a branch-type waveguide layout, 125, depicted in FIG. 1A. The waveguide, 120, includes a first doped region, 130, and may include the entire waveguide layout, 125. As further illustrated in FIGS. 1B and 1C, the waveguide, 120, also includes a second doped region, 135, overlapping the first doped region, 130, and adjacent an outer surface, 140, of the substrate 110, and electrodes, 115. Preferably, the second doped region 135 is located substantially or completely within the first doped region 130.

In one embodiment, the second doped region, 135, has a greater index of refraction than the first doped region, 130. A greater index of refraction may be achieved by a number of means know to one of ordinary skills in the art. For example, the first doped region, 130, may contain one or more first dopants selected from the group of transition metals having an atomic number of 21 through 30, gold, or silver. The second doped region, 135, may also contain one or more of the above-mentioned second dopants. Furthermore, the second dopant's identity may differ from that of the first dopant. Alternately, the first and second doped regions, 130, 135, may contain the same dopant, preferably titanium. In such and other embodiments, the second doped region, 135, may have a dopant density greater than the first doped region, 130, and a dopant gradient, 145, may extend between the first doped region,130, and the second doped region, 135. The first dopant, for example, may have densities ranging from about 10 μgm/cm³ to about 50 μgm/cm³, preferably about 18 μgm/cm³. The second dopant region, for example, may have densities ranging from about 20 μgm/cm³ to about 100 μgm/cm³, preferably about 40 μgm/cm³. In certain preferred embodiments, the gradient, 145, provides a gradual transformation from the first dopant region, 130, to the second dopant region, 135. Any number of conventional approaches may be used to achieve different dopant densities. For example, prior to the thermal diffusion step, further described below, the layer of second dopant, which is thicker than the larger layer of the first dopant, may be layered over the substrate, 110. Alternatively, as discussed below, the duration of thermal diffusion for introducing the first and second dopants into the substrate, 110, may be altered to achieve different dopant densities. Or, in other embodiments, the temperature at which thermal diffusion is carried out may be varied.

As noted above, the present invention preserves mode size matching between the waveguide, 120, and an optical fiber's mode size, thereby maintaining a high optical signal throughput. Thus, in certain preferred embodiments of the present invention, the first doped region, 130, may have a width, 150, about double a width, 155, of the second doped region, 135. For example, in certain advantageous embodiments it may be desirable for the first doped region 130, coupled to an optical fiber (not shown), to have a width 150, ranging from about 6 μm to about 10 μm, preferably about 9 μm. The second doped region 135, in certain advantageous embodiments, may have a width 155 ranging from about 3 μm to about 7 μm, preferably about 4 μm. Other widths, however, are also within the scope of the present invention.

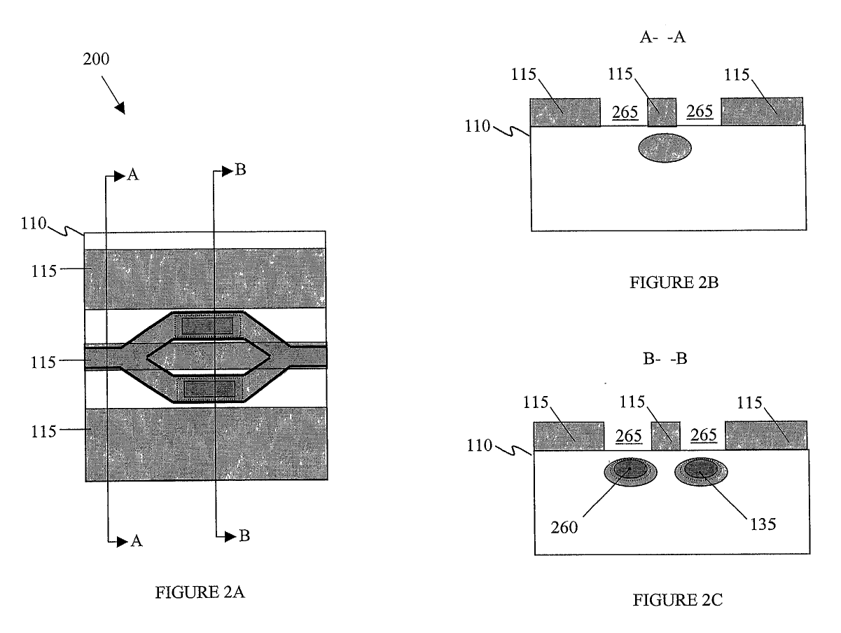

As noted above, the substrate, 110, in certain preferred embodiments may comprise a lithium niobate crystal. Moreover, the lithium niobate crystal may have either a Z cut or X cut configuration. For a Z cut configuration, as FIG. 1C illustrates, the electrode, 115, is preferably located on the substrate directly above a center, 160, of the second doped region. Alternatively, for a X cut configuration, illustrated in FIGS. 2A-2C, a center, 260, of the second doped region, 135, is located in a gap, 265, between electrodes, 115, on the substrate, 110. One of ordinary skill in the art would understand that alternative substrate and crystal cut configurations may require other electrode locations relative to the location of the second doped region. For example, the substrate 110 may be comprised of Lithium Tantalate or Silicon. Thus, the smaller mode size and closer proximity of the second dopant region, 135, to the electrodes, 115, facilitates the use of a lower driving voltage. Moreover, while the devices, 100, 200, illustrated in FIGS. 1A-1C and 2A-2C, respectively, are optical modulators, other optoelectronic devices are within the scope of the present invention.

Another embodiment of the present invention is a method of manufacturing an optical modulator, such as that illustrated in FIGS. 1A-1C. Manufacturing commences with the step of providing a substrate, 110, for example an electrooptic crystal, such as lithium niobate, that may have a thickness ranging from about 100 μm to about 1000 μm, and preferably, a thickness ranging from about 500 μm to about 700 μm. A waveguide, 120, is constructed within the substrate, 110. The waveguide is constructed by forming a first doped region, 130, within the substrate, 110, and forming a second doped region 135 within the first doped region, 130, and adjacent an outer surface, 140, of the substrate and an electrode, 115, formed over the substrate, 110. As noted above, the second doped region's 135 proximity to the surface 140, allows a lower driving voltage to be used.

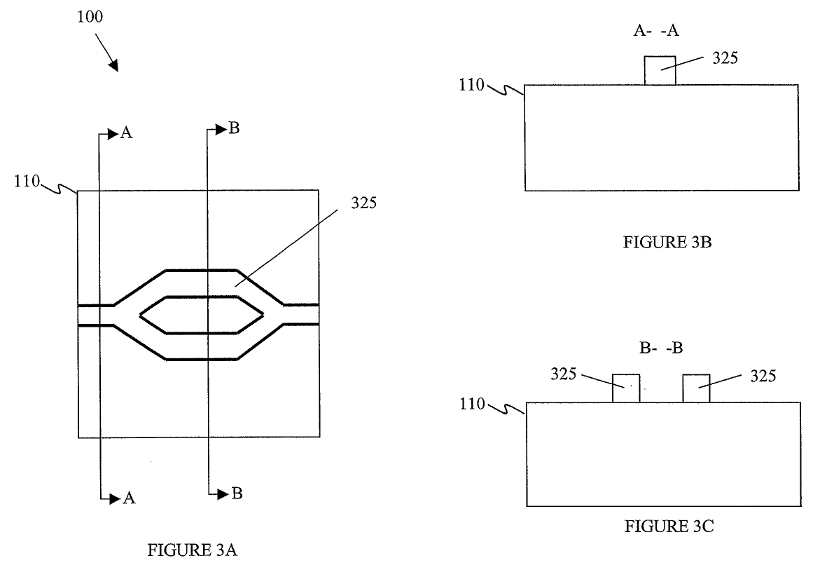

FIGS. 3A-7C, illustrate analogous views of a partially formed optical modulator at selected stages in the manufacturing process. FIG. 3A illustrates a top plan view of a partially completed optical modulator 300, after the steps of layering a first dopant over the substrate to form a first dopant layer (not shown), and patterning the first dopant layer to form a waveguide layout 325, above the substrate 110. The relationship between these structures are further illustrated in the membranous cross-sectional views A-A and B-B, in FIGS. 3B and 3C, respectively. The first dopant layer, and the second dopant layer, introduced below, may be formed by physical vapor deposition (PVD), chemical vapor deposition (CVD) or other conventional processes. Regarding the thickness of the first dopant layer, when the dopant is titanium, for example, the first dopant layer may range from about 20 nm to about 100 nm, and preferably is about 60 nm thick. The thickness of dopant layers, however, is a function of the desired density of first dopant region, 130, in the substrate, 110. Conventional patterning processes may be used to form the waveguide layout, 325, or modulator layout, introduced below. Such processes may involve, for example, forming photoresist portions over a first dopant layer, and using the photoresist portions to pattern the waveguide layout, 325.

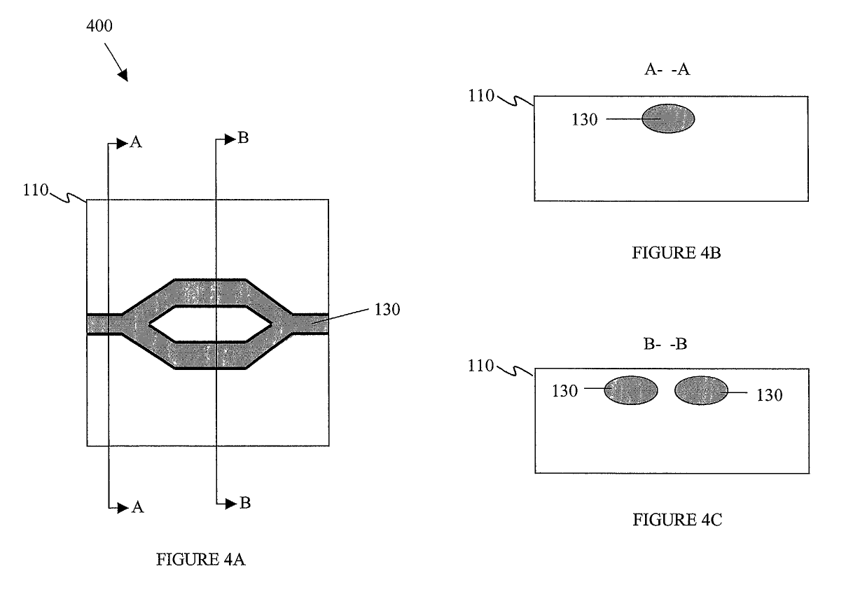

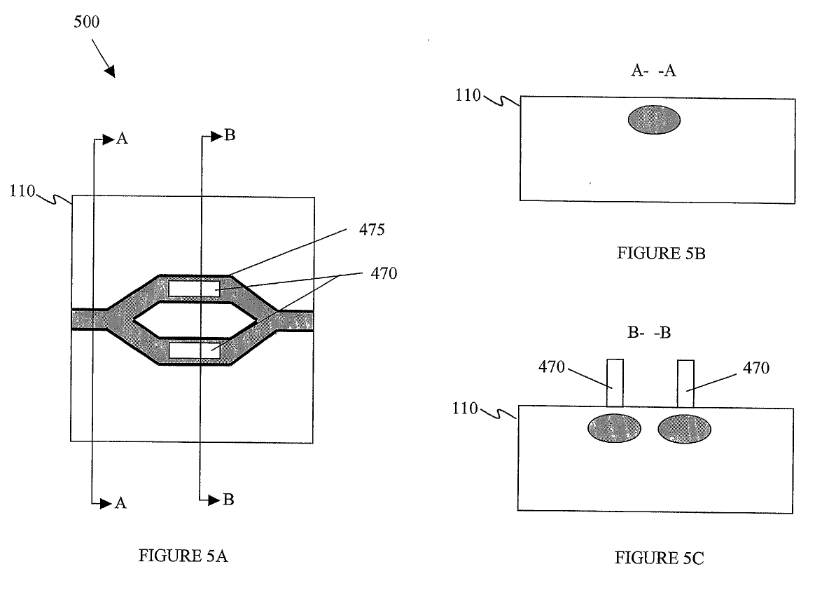

FIGS. 4A-4C show views analogous to FIGS. 3A-3C, of a partially completed optical modulator, 400, after the step of thermally diffusing the waveguide layout 325, shown in FIGS. 3A-3C, into the substrate, 110, to form the first doped region, 130. FIGS. 5A-5C shows analogous views for one embodiment of a partially completed optical modulator, 500, after the steps of layering a second dopant over the substrate containing the first doped region, 130, to form a second dopant layer (not shown). The views in FIGS. 5A-5C are depicted after patterning the second dopant layer to form a waveguide modulator layout, 470, within a boundary, 475, defined by the waveguide lay out, 325, shown in FIGS. 3A-3C. Regarding the thickness of the second dopant layer, when the dopant is titanium, for example, the second dopant layer may range from about 40 nm to about 200 nm, and preferably is about 130 nm thick. As noted above, however, thickness is a function of the desired density of second dopant region, 135, in the substrate 110.

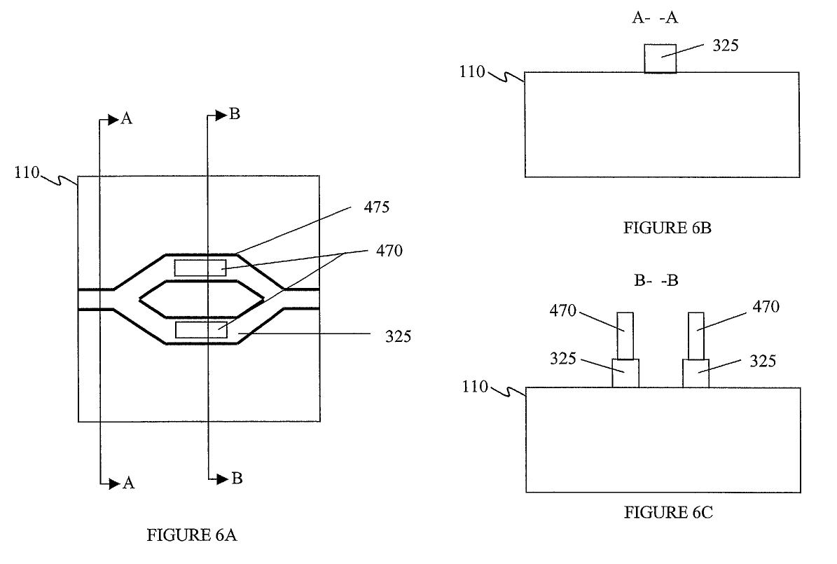

FIGS. 6A-6C also shows analogous views of a partially completed optical modulator 600, illustrating an alternative method of manufacturing. The initial steps of layering a first dopant over the substrate and patterning the first dopant to form a waveguide layout, 325, proceed similar to that illustrated in FIGS. 3A-3C. The next step, however, involves layering a second dopant over the waveguide layout, 325, to form a second dopant layer (not shown) and then patterning the second dopant layer to form the modulator waveguide layout, 470, within the boundary, 475, defined by the waveguide layout, 325. This embodiment of the manufacturing method, therefore involves a single thermal diffusion step, discussed below.

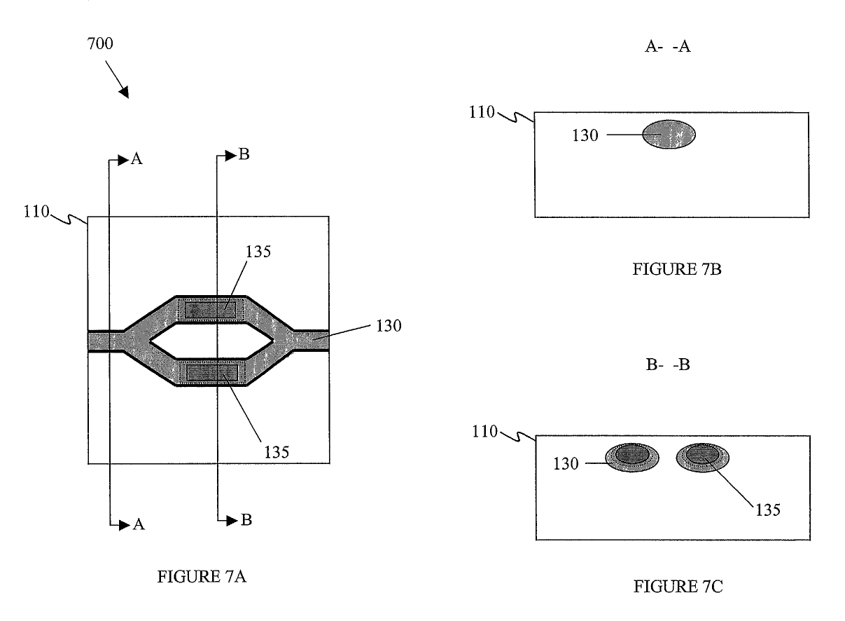

FIGS. 7A-7C shows top plan and cross-sectional views of a partially completed optical modulator 700, illustrating the modulator, 700, following a thermal diffusion method step. This step follows either the thermal diffusion of the waveguide modulator layout, 325, and layering and patterning the modulator waveguide layout, 475, shown in FIGS. 5A-5C, or the layering and patterning the waveguide, 325, and modulator waveguide layout, 475, shown in FIGS. 6A-6C. Thus, either of the partially completed optical modulators, 500, 600, may be further processed by thermally diffusing the waveguide modulator layout, 475, alone, or the waveguide layout, 325, plus the modulator outline, 475, into the substrate, 110, to form the second doped region, 135, within the first doped region,130. Conventional procedure and materials could then be used to form electrodes, 115, over the substrate, 110, to form an optical modulator device, 100, such as that illustrated in FIGS. 1A-1C.

Thermal diffusion may be carried out using conventional annealing processes known to one of ordinary skill in the art. A temperature ranging from about 900° C. to about 1100° C., for a time ranging from about 7 hours to about 10 hours, may be used for example. As indicated above, the annealing time and temperature may be altered to accommodate different dopants and substrates combinations. Thus, depending on the time and temperature used, more or less of the dopant may remain after the annealing process. For example, in certain embodiments, the entire dopant layer comprising the waveguide or modulator waveguide layout, may be diffused into the substrate. However, in other embodiments, portions of the dopant may remain after the annealing process, and must subsequently be removed by conventional processes.

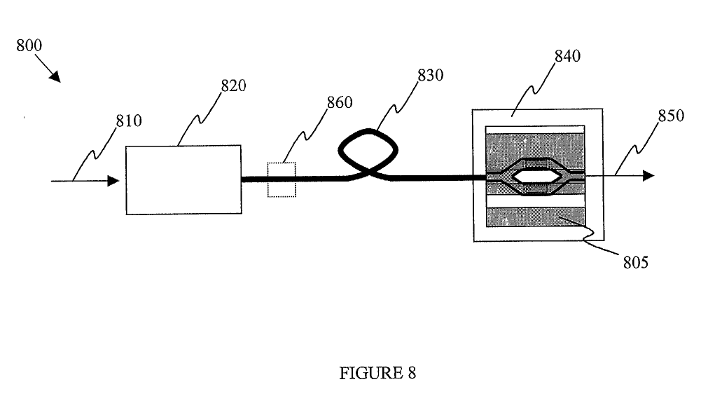

Turning to FIG. 8, illustrated is a cross-sectional view of an optical communications system, 800, which may form one environment in which an optical modulator, 805, made according to the principles of the present invention, may be used. An initial signal, 810, enters a transmitter, 820, of the optical communications system, 800. The transmitter, 820, receives the initial signal, 810, addresses the signal, 810, and sends the resulting information across an optical fiber, 830, to a receiver, 840. The receiver, 840, receives the information from the optical fiber, 830, addresses the information and sends an output signal, 850. As illustrated in FIG. 8, the optical modulator, 805, may be included within the receiver, 840. However, the optical modulator, 805, may also be included anywhere in the optical communications system, 800, including the transmitter, 820. The optical communications system, 800, however, is not limited to the devices previously mentioned. For example, the optical communications system, 800, may include an element, 860, such as a laser, diode, modulator, optical amplifier, optical waveguide, photodetectors, or other similar device.

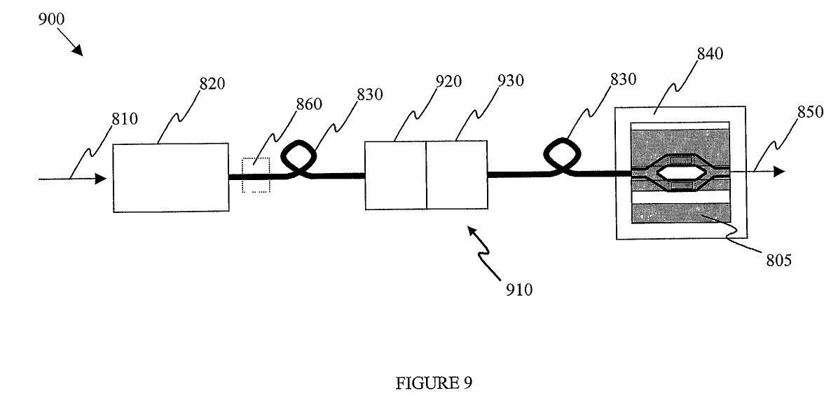

FIG. 9 illustrates an alternative optical communications system, 900, having a repeater, 910, including a second transmitter, 920, and a second receiver, 930, located between the transmitter, 820, and the receiver, 840, as well as the optical modulator, 805.

Although the present invention has been described in detail, those skilled in the art should understand that they can make various changes, substitutions and alterations herein without departing from the spirit and scope of the invention.

What is claimed is:

1. An optical modulator, comprising:
a substrate;
electrodes located over said substrate; and
a waveguide located within said substrate, said waveguide including:
a first doped region, and
a second doped region overlapping said first doped region and located adjacent an outer surface of said substrate and said electrodes.

2. The optical modulator as recited in claim 1 wherein said second doped region has a refractive index greater than a refractive index of said first doped region.

3. The optical modulator as recited in claim 1 wherein said second doped region has a dopant density greater than said first doped region, and a dopant gradient extends between said first doped region and said second doped region.

4. The optical modulator as recited in claim 1 wherein said substrate comprises a lithium niobate crystal.

5. The optical modulator as recited in claim 4 wherein said lithium niobate crystal has a Z cut configuration and said electrodes are located on said substrate above a center of said second doped region.

6. The optical modulator as recited in claim 4 wherein said lithium niobate crystal has a X cut configuration and a center of said second doped region is located in a gap between said electrodes on said substrate.

7. The optical modulator as recited in claim 1 wherein said first doped region contains a dopant selected from the group consisting of:
transition metals having an atomic number of 21 through 30,
gold, and
silver.

8. The optical modulator as recited in claim 1 wherein said first and second doped regions contain a dopant comprising titanium.

9. The optical modulator as recited in claim 1 wherein said first doped region has a width about double a width of said second doped region.

10. The optical modulator as recited in claim 9 wherein said width of said first doped region is about 6 μm and said width of said second doped region is about 3 μm.

11. The optical modulator as recited in claim 1 wherein said second doped region is located completely within said first doped region.

12. The optical modulator as recited in claim 1 wherein said optical modulator forms a portion of an optical communications system further including a transmitter coupled to said optical modulator and input and output optical fibers coupled to said optical modulator.

13. A method of manufacturing an optical modulator, comprising:
providing a substrate;
forming electrodes over said substrate; and
constructing a waveguide within said substrate by
forming a first doped region within said substrate, and
forming a second doped region to overlap said first doped region and adjacent an outer surface of said substrate and said electrode.

14. The method as recited in claim 13 wherein forming said first doped region comprises:
layering a first dopant over said substrate to form a first dopant layer;
patterning said first dopant layer to form a waveguide layout; and
thermally diffusing said waveguide layout into said substrate to form said first doped region.

15. The method as recited in claim 14 wherein forming said second doped region comprises:
layering a second dopant over said substrate containing said waveguide layout to form a second dopant layer;
patterning said second dopant layer to form a waveguide modulator layout within a boundary defined by said waveguide layout; and
thermally diffusing said waveguide modulator layout into said substrate to form said second doped region within said first doped region.

16. The method as recited in claim 13 wherein forming said first and said second doped regions comprises:
layering a first dopant over said substrate to form a first dopant layer;
patterning said first dopant layer to form a waveguide layout;
layering a second dopant over said waveguide layout to form a second dopant layer;
patterning said second dopant layer to form a modulator waveguide layout within a boundary defined by said waveguide layout; and
thermally diffusing said waveguide layout and said modulator waveguide layout into said substrate to form said second doped region within said first doped region.

17. The method as recited in claim 13 wherein forming said second doped region further includes said second doped region having a dopant density greater than said first doped region, and a dopant gradient extending between said first doped region and said second doped region.

18. The method as recited in claim 13 wherein forming said electrodes further includes forming said electrode on said substrate directly above a center of said second doped region.

19. The method as recited in claim 13 wherein forming said electrode further includes forming said electrodes on said substrate so that a center of said second doped region is located in a gap between said electrodes.

20. An optical communications system, comprising:
an optical modulator, including;
a substrate;
electrodes;
a waveguide located within the substrate, the waveguide including:
a first doped region, and
a second doped region overlapping said first doped region and adjacent an outer surface of said substrate and said electrode; and
input and output optical fibers coupled to said optical modulator.

21. An optical communications system as recited in claim 20 wherein said second doped region has a dopant concentration greater than a dopant concentration of said first doped region and said waveguide has a mode size substantially equal to a mode size of said input or output optical fibers.

22. The optical communications system as recited in claim 20 further includes said optical modulator coupled to devices selected from the group consisting of:
lasers;
photodetectors;
optical amplifiers;
transmitters; and
receivers.
